(19) United States
(12) Patent Application Publication
(10) Pub. No.: US 2015/0013717 A1
(43) Pub. Date: Jan. 15, 2015

(54) Disposable Absorbent Liquid Impermeable Coverings

(71) Applicant: FreeseTEC, Bryn Mawr, PA (US)

(72) Inventors: Andrew Freese, Chester Springs, PA (US); Jacquelyn Alutis, Schwenksville, PA (US)

(21) Appl. No.: 13/935,346

(22) Filed: Jul. 3, 2013

(51) Int. Cl. A41D 19/015; B08B 1/00; A41D 19/00

(52) U.S. Cl. CPC A41D 19/01594; A41D 19/0006; B08B 1/006
USPC 134/6; 2/69

(57) ABSTRACT

A single use, disposable system for cleaning that protects the individual's hands that avoids direct skin and hand contact with the material being cleaned, reducing the likelihood of transmission of pathogens, germs, dirt, odiferous material, noxious material, and allowing the individual to then progress forward without having to wash, cleanse or dry their hands, has been developed. The system includes an absorbent material such as a paper towel, baby wipe, surface cleaning wipe, or medical wipe, adhered on at least one surface to a flexible liquid or waste impermeable covering such as a glove, mitt, or baggie.

### FIELD OF THE INVENTION

The present invention is generally in the field of disposable gloves having an absorbent surface bound thereto, permitting one to wipe up liquids without getting wet.

### BACKGROUND OF THE INVENTION

The invention of the paper towel revolutionized the medical, food and cleaning industry. Prior to that time, towels were used that required washing and drying, and, in the case of the medical industry, extensive sterilization.

However, particularly in the medical and food industry, one still has to wear gloves because the paper towels absorb liquids and other wastes, but do not prevent contamination of the person or other surfaces contacted by the paper towels. Accordingly, medical personnel and food handlers have to put on gloves before handling paper towels, cleaning surfaces or other contaminated areas, then disposing of the paper and the gloves before handling another patient or surface. This is expensive and time consuming.

It is therefore an object of the present invention to provide disposable absorbent gloves which prevent contact with the handler, which can be stored in little space, approximately the same as a paper towel roll, and which are cheap and easy to make and use.

### SUMMARY OF THE INVENTION

A single use, disposable system for cleaning that protects the individual's hands that avoids direct skin and hand contact with the material being cleaned, reducing the likelihood of transmission of pathogens, germs, dirt, odiferous material, noxious material, and allowing the individual to then progress forward without having to wash, cleanse or dry their hands, has been developed. The system includes an absorbent material such as a paper towel, baby wipe, surface cleaning wipe, or medical wipe, adhered on at least one surface to a flexible liquid or waste impermeable covering such as a glove, mitt, or baggie.

The absorbent material can be in the form of a sheet or shaped to correspond to the impermeable material, on one or both sides of the impermeable material covering. In the preferred embodiment, the disposable absorbent is adhered to the impermeable covering with an adhesive, and rolled or stacked together the same as rolls of paper towels. The absorbent material can be separated by tearing of a perforated line between impermeable coverings.

### BRIEF DESCRIPTION OF THE DRAWINGS

FIG. 1 is a prospective view of a glove on a sheet of absorbent material.

FIG. 2 is a prospective view of a mitt on a sheet of absorbent material cut to correspond to the shape of the mitt.

FIG. 3 is a prospective view of a roll of gloves adhered to absorbent sheets, separated by perforated lines.

### DETAILED DESCRIPTION OF THE INVENTION

A number of designs for paper, cloth, or other material based wipes, towels, towelettes, rags and related cleaning surfaces have been developed, but one common feature is that they lack a protective barrier for the user of the device. This means that in dangerous or unpleasant settings often the individual using the device is exposed to toxic chemicals, unpleasant materials, blood-borne or other pathogens, and materials that stain or leave odors. This leads to inefficiencies, and the need for the user to then wash, cleanse and/or dry her hand. It also can directly expose the user to dangerous or undesirable products or waste.

The design permits the user to incorporate the cleaned material in a self-contained unit that can be thrown away into the rubbish or other container. In this embodiment, a paper towel roll is manufactured with a plastic mitt attached. The user can place his/her hand into the mitt, break off the appropriate and predetermined size paper towel, and then clean the dirty or otherwise affected surface. The user's hand is dry and does not require additional cleansing or drying. This is clearly far more efficient and less unsettling compared to the traditional paper towel design. Applications to dangerous, toxic chemicals, blood products, human or animal excrement, and others are even more advantageous in that once again the user's hand is protected from contamination by any of these materials.

### I. Fluid Impermeable Absorbent Coverings

### A. Absorbent Substrates

This system can utilize any paper or cloth towel system, which are typically folded in a stack or incorporated into a typical ‘roll’ design. It can be used in most industrial applications with a thicker paper or cloth towel. It can be used for a scrub or scouring pad.

Additional embodiments of the absorbent substrate include baby or child wipes, household cleaning wipes or towelettes, bathroom materials such as toilet cleansing wipes or bathroom tissue.

The absorbent material is typically a woven or non-woven paper (cellulose), cotton or other absorbent material such as polyacrylic beads or gel, diatomaceous earth, silica, or rice. Until the 1980s, water absorbing materials were cellulosic or fiber-based products. Choices were tissue paper, cotton, sponge, and fluff pulp. The water retention capacity of these types of materials is only up to 20 times their weight. In the early 1960s, the United States Department of Agriculture (USDA) was conducting work on materials to improve water conservation in soils. They developed a resin based on the grafting of acrylonitrile polymer onto the backbone of starch molecules (i.e. starch-grafting). The hydrolyzed product of the hydrolysis of this starch-acrylonitrile co-polymer (“SAP”) gave water absorption greater than 400 times its weight and the gel did not release liquid water the way that fiber-based absorbents do. The USDA gave the technical know-how to several USA companies for further development of the basic technology. A wide range of grafting combinations were attempted including work with acrylic acid, acrylamide and polyvinyl alcohol (PVA). Water absorbing polymers, which are classified as hydrogels when cross-linked, absorb aqueous solutions through hydrogen bonding with water molecules. A SAP's ability to absorb water is a factor of the ionic concentration of the aqueous solution. In deionized and distilled water, a SAP may absorb 500 times its weight (from 30-60 times its own volume), but when put into a 0.9% saline solution, the absorbency drops to maybe 50 times its weight. The presence of valence cations in the solution will impede the polymer's ability to bond with the water molecule. The total absorbency and swelling capacity are controlled by the type and degree of cross-linkers used to make the gel. Low density cross-linked SAP generally have a higher absorbent capacity and swell to a larger degree. These types of SAPs also have a softer and more sticky gel formation. High cross-link density polymers exhibit lower absorbent capacity and swell, but the gel strength is firmer and can maintain particle shape even under modest pressure.

### B. Impermeable Covering

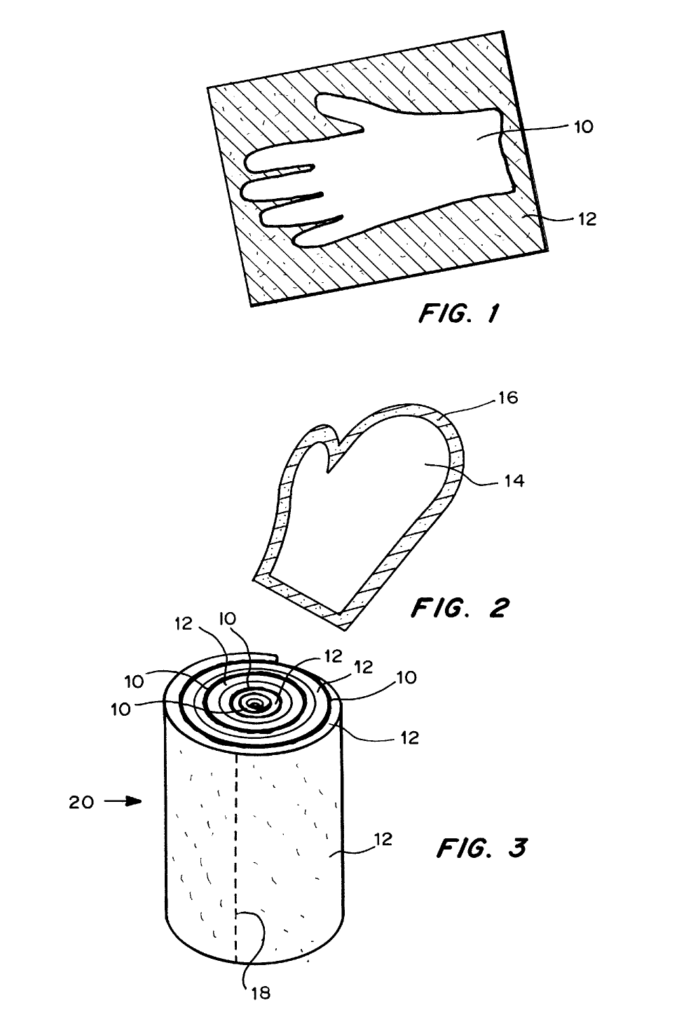

The impermeable covering is attached to the absorbent substrate. As shown in FIGS. 1 and 2, a glove 10 or mitt 14 can be devised to fit either the right hand or the left hand, or either. The covering can also be a simple baggie, such as those used to clean up refuse when exercising a pet.

The covering can be designed to allow the user to cleanse the desired surface, roll up the dirty material within the confines of the paper or cloth towel, and then incorporate these within the reversed plastic mitt or glove, and then discard this combination into a trash container, while keeping the user's hands dry and clean.

The impermeable material must be flexible. Typical materials include polyethylene, nitrile, latex, and vinyl, although other polymeric materials that are relatively fluid impermeable can be used. The material does not have to be completely impermeable, since the liquid will typically be absorbed initially by the absorbent materials. The material is typically selected based on the application. For example, if the liquid is a solvent, oil or gasoline, the impermeable material would have to be resistant to the liquid. All of the materials are typically useful when the liquid or waste material is aqueous based. For medical applications, the material must be impermeable to bacteria and viruses.

### C. Adhesives

In the preferred embodiment, the adhesive is a water based adhesive that is applied to the impermeable covering by spraying, dipping, or coating, which is then contacted with the absorbent material. Many suitable adhesives are commercially available, including FDA approved adhesives.

Suitable adhesives are available from companies such as GlueFast, Neptune, N.J., 3M, Master Bond, and many others.

### II. Assembly

The covering is adhered to the absorbent material. In the preferred embodiment, adhesive is applied to one surface of the impermeable material, which is then contacted with the absorbent material. These may be sheets, material cut to match the shape of the impermeable material (FIG. 1, absorbent 12, impermeable material in the shape of a glove 10; FIG. 2, absorbent 16, impermeable material in shape of mitt 14), or long rolls (FIG. 3) such as rolls 20 of paper towels having each area contacting a single covering separated by perforations 18 allowing easy separation of each piece.

In another embodiment, absorbent material is placed on both sides of the impermeable materials, analogous to a sandwich, with the glove, mitt or baggie in the middle.

In another embodiment, tape, especially double sided tape, may be placed between the impermeable material and the absorbent material to adhere the materials together.

The composites are then rolled, stacked, or individually sealed for storage and distribution.

### III. Use

The user places his hand in the glove, mitt or baggie, wipes up the liquid or waster, peels off the glove, mitt or baggie, and disposes of the used article. In some embodiments, the glove, mitt or baggie is peeled off inside out, so that the soiled absorbent material is trapped within the glove, mitt or baggie, making for a very neat package to dispose.

Modifications and variations of the present invention will be obvious to those skilled in the art and are intended to come within the scope of the appended claims.

I claim:

1. A single use, disposable liquid impermeable, flexible covering for a hand which is adhered on at least one exterior surface to an absorbent material.

2. The covering of claim 1 in the shape of a glove, mitt or baggie.

3. The covering of claim 2 wherein the absorbent material is a sheet on one or both sides of the covering.

4. The covering of claim 3 wherein the sheets are separated or perforated.

5. A method of cleaning a surface, removing waste or absorbing a liquid comprising placing a hand in a single use, disposable liquid impermeable, flexible covering for a hand which is adhered on at least one exterior surface to an absorbent material and cleaning the surface, removing waste or absorbing the liquid.

6. The method of claim 5 wherein the covering is in the shape of a glove, mitt or baggie.

7. The method of claim 6 wherein the absorbent material is a sheet on one or both sides of the covering.

8. The method of claim 7 wherein the sheets are separated or perforated.

9. The method of claim 5 further comprising peeling off the covering so that the inside of the covering folds over and contains the absorbent material.

10. A method of making a single use, disposable liquid impermeable, flexible covering for a hand which is adhered on at least one exterior surface to an absorbent material comprising providing an adhesive on a surface of the flexible impermeable material or the absorbent material then contacting the other material to the material with the adhesive.

11. The method of claim 10 wherein the covering is in the shape of a glove, mitt or baggie.

12. The method of claim 11 wherein the absorbent material is a sheet on one or both sides of the covering.

13. The method of claim 12 wherein the sheets are separated or perforated.

14. The method of claim 10 comprising rolling or stacking the adhered absorbent covering.
